(19) United States
(12) Patent Application Publication
(10) Pub. No.: US 2009/0301431 A1
(43) Pub. Date: Dec. 10, 2009

(54) Method of Controlling Common Rail Fuel Injection Device

(75) Inventors: Mitsuyoshi Kawarabayashi, Osaka (JP); Hajimu Imanaka, Osaka (JP); Nobu Kobayashi, Osaka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: YANMAR CO., LTD., Osaka-shi (JP)

(21) Appl. No.: 12/438,858

(22) PCT Filed: Jul. 23, 2007
(86) PCT No.: PCT/JP2007/064455

§ 371 Date: Apr. 3, 2009

(30) Foreign Application Priority Data
Aug. 31, 2006 (JP) 2006-236242

(51) Int. Cl. F02B 3/00; F02D 41/30

(52) U.S. Cl. 123/299; 701/105

(57) ABSTRACT

A method for controlling a common-rail fuel injection system, which avoids the adverse effect of the pilot injection on the main injection while driving an engine and maximizes the cleaning up of the exhaust gas by the pilot injection or the like, is provided. In the common-rail fuel injection system performing a multistage injection, a pilot injection timing θp at a crankshaft angle and a main injection timing θm at the crankshaft angle base are controlled by a ECU. The ECU calculates a pilot injection interval Tpin at a time base and adjusts the main injection timing θm when the pilot injection interval Tpin is less than the predefined threshold (1 (ms) in the present embodiment).

### BACKGROUND OF THE INVENTION

1. Field of the Invention

The present invention relates to a technology of a common-rail fuel injection system applied to a diesel engine, more specifically, a method for controlling a main injection timing when performing a multistage injection control.

2. Background Art

Conventionally, there are a well-known and widely-used technology for reducing PM (Particulate Matter) or Nox (nitrogen oxide) contained in a an exhaust gas, by a multistage injection control which performs multiple injections such as a pre-injection, a pilot injection, a main injection, an after injection and post-injection, provided with common-rail fuel injection system, as an effective means for cleaning up the exhaust gas in a diesel engine.

However, it is known that, when performing the multiple injection control, a fuel injection rate in the main injection is fluctuated, due to a pressure fluctuation caused with the termination of the pilot injection, so that an engine rotation number is unstable. Especially in the idling state having lower engine rotation number, the engine rotation number is susceptibly fluctuated, due to the slight change of the fuel injection rate, thereby causing a problem of undermining the stability of the engine rotation number.

In this regard, in order to solve the above-mentioned problem, a technology for controlling the injection condition on the pilot injection, going by the starting of the main injection, so that the period from the termination of the pilot injection and the starting of the main injection is constant, in response to a idling driving state of the engine, is disclosed in JP1998-205383 and become public knowledge.

However, the problem on the pressure fluctuation caused with the termination of the pilot injection is always caused while driving the engine, not apply only to the idling driving state. The injection interval between the pilot and main injections was set up to be longer, so that the pressure fluctuation of the fuels by the pilot injection did not influence the main injection, as the previous way to approach this problem while driving the engine. Accordingly, it was difficult for the technology to be used in the area where the effects such as the cleaning up of the exhaust gas by the pilot injection are most effectively exerted.

In consideration to the above-discussed problems, it's a problem of the invention to provide a method for controlling a common-rail fuel injection system, which avoids the adverse effect of the pilot injection on the main injection while driving the engine and maximizes the cleaning up of the exhaust gas by the pilot injection or the like.

### BRIEF SUMMARY OF THE INVENTION

In a common-rail fuel injection system of the present invention, a method for controlling a common-rail fuel injection system controlling a pilot injection timing based on a crankshaft angle and a main injection timing based on a crankshaft angle by a controller, in the common-rail fuel injection system which performs a multistage injection, comprises the step of calculating a pilot injection interval at a time base by the controller, and adjusting the main injection timing based on crankshaft angle, so as to secure the pilot injection interval at the time base, when the pilot injection interval is the predefined threshold or less.

In the common-rail fuel injection system of the present invention, the pilot injection interval at the time base is calculated and output by the controller, based on the pilot injection timing based on crankshaft angle, the main injection timing based on crankshaft angle and an engine rotation number at the calculation time.

In the common-rail fuel injection system of the present invention, a correction main injection timing at a time base is adopted as the main injection timing, by adjusting so as to delay by the time with a combination of the pilot injection time and the pilot injection interval at the time base, going by the pilot injection timing based on crankshaft angle, based on the pilot injection timing based on crankshaft angle, the pilot injection time and the pilot injection interval at the time base.

According to the present invention, in the area where the main injection quantity is influenced by the pilot injection interval, the fluctuation of the pilot injection interval due to that of the engine rotation number can be prevented.

According to the present invention, the area where the pilot injection interval is controlled by the time base can be decreased, by using the engine rotation number at calculation time as a control element.

Also, the pilot injection interval can be adequately evaluated even at the rapid acceleration/deceleration time.

According to the present invention, the pilot injection interval can be adequately maintained, by correct the main injection timing.

### BRIEF DESCRIPTION OF THE DRAWINGS/FIGURES

FIG. 1 is a schematic diagram of an entire construction of a common-rail fuel injection system according to an embodiment of the present invention.

FIG. 2 is a schematic diagram of an entire construction of an injector according to an embodiment of the present invention.

FIG. 3 is a diagram of showing a correlation between a pilot injection interval and a main injection quantity.

FIG. 4 is a diagram of showing a correlation between a pilot injection and a main injection.

FIG. 5 is a diagram of contrasting the respective injection timings on each of the angle and time base.

FIG. 6 is a diagram of contrasting the respective injection timings on each of the angle and time base if Tpin≧1 (ms) (Tpin is 1 (ms) or more).

FIG. 7 is a diagram of contrasting the respective injection timings on each of the angle and time base if Tpin<1 (ms) (Tpin is less than 1 (ms)).

FIG. 8 is a flow diagram of calculation of the main injection timing

70 ECU (controller)
100 common-rail fuel injection system
θp pilot injection timing (crankshaft angle based)
θm main injection timing (crankshaft angle based)
θpin pilot injection interval (crankshaft angle based)
Tpin pilot injection interval (time base)
Qp pilot injection time
Qm main injection time

### DETAILED DESCRIPTION OF THE INVENTION

Embodiments of the present invention will be described.

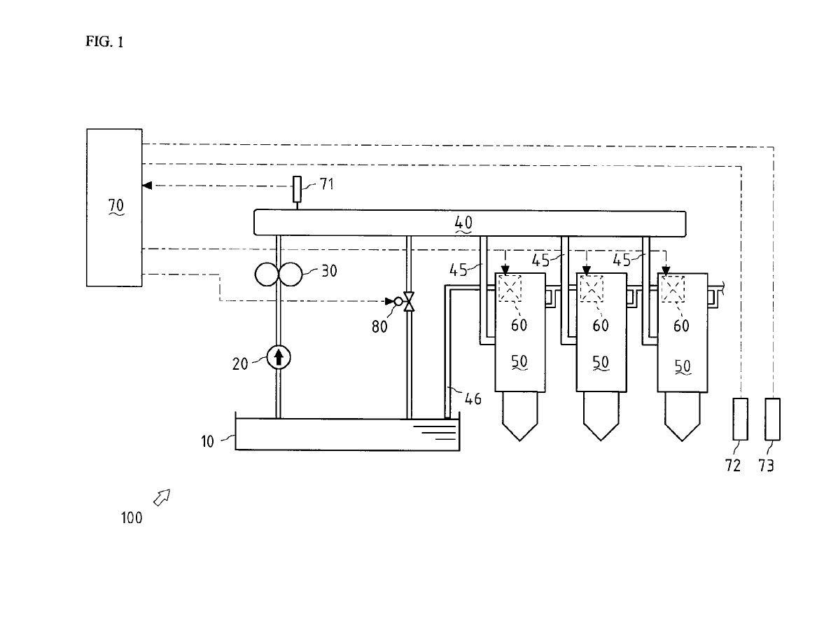

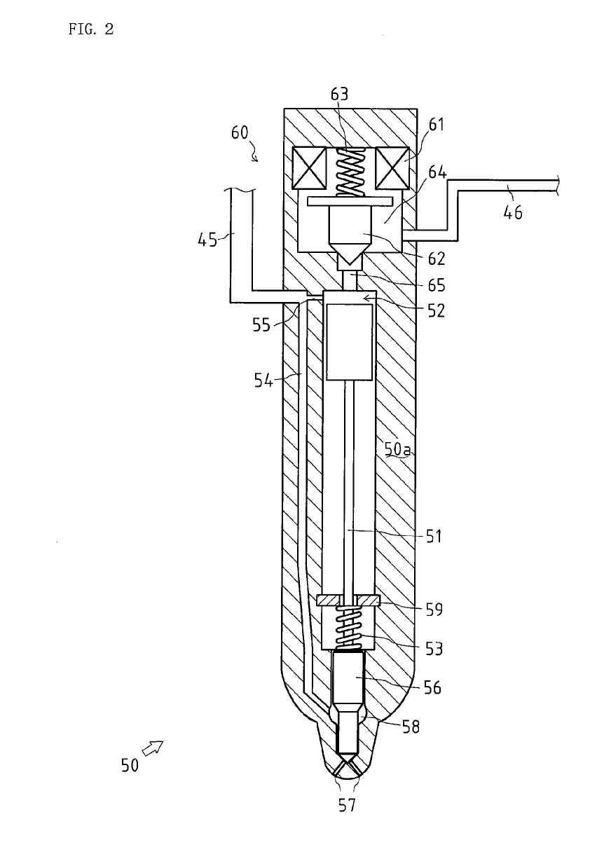

At first, a construction of a common-rail fuel injection system provided with a diesel engine according to embodiments of the present invention will be described, with reference to FIG. 1 or 2.

As shown in FIG. 1, a common-rail fuel injection system 100 comprises plurality of injectors 50 which mainly injects the fuels into the respective machineries and a common-rail 40 which accumulates the highly-pressurized fuels so as to distribute the respective injectors 50.

The injectors 50 are electrically-controlled fuel injection system provided with the respective cylinders when they are multicylinder and is connected to the common-rail 40 via a high-pressure piping 45.

The common-rail 40 is connected to a fuel tank 10 via a low pressure pump 20 and a high pressure pump 30, as well as it is connected to the fuel tank 10 via a pressure regulation valve 80.

Due to the above construction, the fuels are pumped from the fuel tank 10 via the low pressure pump 20 and the high pressure pump 30 into the common-rail 40, as well as they are accumulated to the given pressure via a discharge rate regulation valve provided with the high pressure pump 30 and the pressure regulation valve 80 into the common-rail 40, so as to be distributed into the respective injectors 50 and be injected into the respective cylinders.

A ECU (Electronic Control Unit: a controller) 70 issues output signals to the injectors 50, based on input signals from the respective sensors as well as an internal memory program and a map data or the like, so as to control the operations of the fuel injections in the injectors 50 or the like.

Also, the ECU 70 is connected to a solenoid valve 60 operating the injectors 50 so as to control an on/off operation of the solenoid valve 60, and is connected to the pressure regulation valve 80 so as to control an on/off operation of the pressure regulation valve 80.

Further, the ECU 70 is connected to a pressure sensor 71 which detects the pressure in the common-rail 40, a rotation number sensor 72 which detects the rotation number of the diesel engine, a load sensor 73 which detects the load of the diesel engine or the like, so that it is constituted so as to detect the operating conditions on the respective portions of the diesel engine and the pressure in the common-rail 40.

Incidentally, descriptions on the respective sensors will be omitted, there is well-known angle sensor which issues a pulse signal according to the given rotation angle of a crankshaft as the rotation number sensor 72a, a sensor which detects a depression degree of an accelerator pedal as the load sensor 73 or the like.

Next, constructions/behaviors of the injectors 50 will be described, with reference to FIG. 2.

As shown in FIG. 2, a command piston 51 is vertically, slidably provided in an injector body 50a. The command piston 51 is biased downwardly due to a fuel pressure in a control chamber 52. The highly-pressurized fuels supplied from the common-rail 40 to a fuel supply route 54 are supplied via an orifice 55 to the control chamber 52.

The control chamber 52 is provided on the upper side thereof with a solenoid valve 60. The solenoid valve 60 is constituted so that a valving element 62 is withdrawn upward against the biasing force of a spring 63, by energization of a solenoid 61. The switching of the solenoid valve 60 is controlled due to the controller 70. The fuel pressure in the control chamber 52 is discharged via an orifice 65 to a low pressure side piping 46 by the opening of the solenoid valve 60, so as to attenuate the down ward biasing force of the command piston 51

A needle valve 56 is vertically, slidably provided on the lower side of the command piston 51. The upper side of the needle valve 56 abuts on the lower end of the command piston 51. The needle valve 56 is provided at a sliding portion thereof with a nozzle chamber 58. The highly-pressurized fuels supplied from the common-rail 40 to the fuel supply route 54 is supplied to the nozzle chamber 58. The needle valve 56 is provided in a valve casing on the upper side thereof with a cover ring 59, and a spring 53 is interposed between the needle valve 56 and the cover ring 59 so as to bias the needle valve 56 downward.

When the fuel pressure in the control chamber 52 is high and a total of downward biasing forces of the command piston 51 and the spring 53 is larger than the upward biasing force against the needle valve 56 due to the fuel pressure in the nozzle chamber 58, the needle valve 56 is moved downward so as to close discharge orifices 57, 57. Meanwhile, when the solenoid 61 is energized and the raising force against the needle valve 56 by the fuel pressure in the nozzle chamber 58 is larger than a total of the downward biasing force against the needle valve 56 by the command piston 51 and that of the spring 53, the discharge orifices 57, 57 are opened.

Due to the above construction, when the solenoid valve 60 (the valving element 62) is opened by the control of the ECU 70, the highly-pressurized fuels in the control chamber 52 are discharged via a valve chest 64 to the low pressure side piping 46, so as to lower the pressure in the control chamber 52. At the same time, the downward biasing force against the command piston 51 is lowered, so that the needle valve 56 is lifted due to the fuel pressure (the opening valve pressure) in the nozzle chamber 58. Accordingly, the discharge orifices 57, 57 are opened so as to inject the fuels.

When the solenoid valve 60 (the valving element 62) is closed by the control of the ECU 70, The pressure of the highly-pressurized fuels is accumulated into the control chamber 52, and the command piston 51 is moved downward by the pressure. Accordingly, the needle valve 56 is moved downward and the discharge orifices 57, 57 are closed so as to terminate the fuel injection.

The construction of the common-rail fuel injection system provided with the diesel engine according to the embodiment of the present invention was described, as identified above.

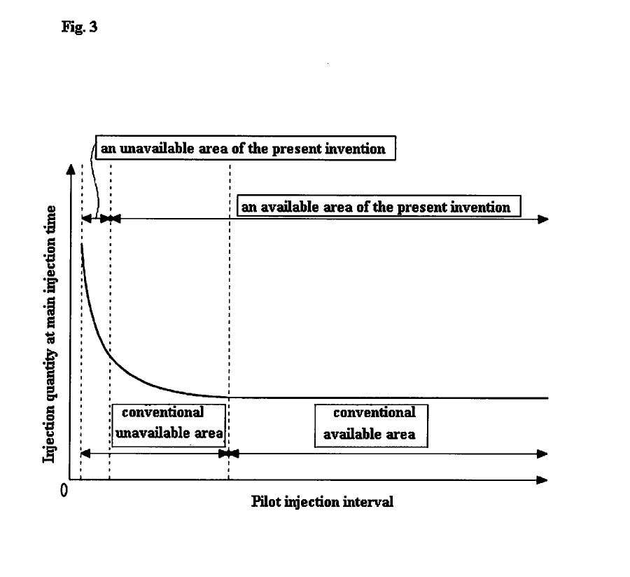

Next, a method for controlling a multistage injection according to an embodiment of the present invention will be described, with reference to FIGS. 3 to 8.

As shown in FIG. 3, conventionally, it has been confirmed that, while performing the multistage injection, when the interval between the pilot and the main injection was shortened, the pilot injection had an influence on the injection quantity at the main injection time, if the interval to the pilot injection was shorten up to the constant time interval or below. This is a phenomenon caused because the main injection is affected due to the pressure drop when the main injection is performed before the pressure drop is settled down, as a constant time is required until the pressure drop in the nozzle is settled down after the pilot injection. Consequently, the area available (settable) at the pilot injection interval was restricted, so that the pilot injection interval could not be shortened up to a certain time interval or below.

In this regard, in the present invention, the multistage injection is controlled so that a stable injection can be realized, even in the area that was conventionally unavailable (unsettable) at the pilot injection interval.

Hereinafter, the control method according to the present invention will be described, showing a concrete flow diagram of calculation of the main injection timing.

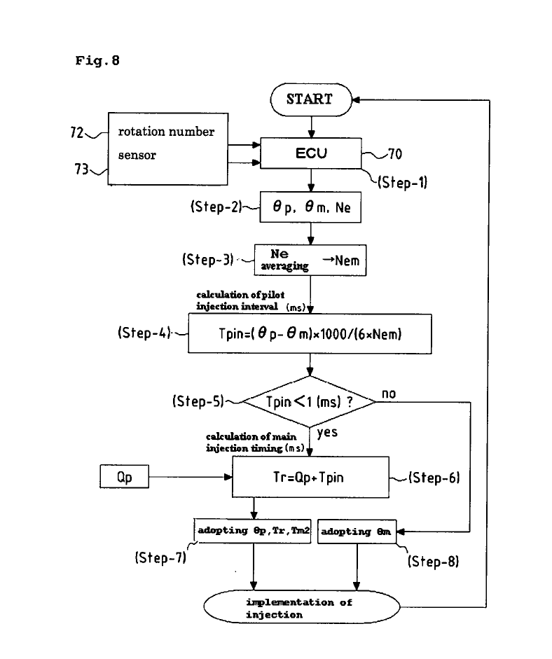

As shown in FIG. 8, the ECU 70 is constructed so that it is connected to the rotation number sensor 72 and the load sensor 73 and the signal of the engine rotation number Ne or the other signal is input from these sensors into the ECU 70 so as to recognize the operating (load) condition of the engine based on the values (Step, S1). The pilot injection timing θp and the main injection timing θm suitable for the present operating condition are derived, on the basis of the recognized operating (load) condition (the engine rotation number Ne or the like) and a map information preliminary memorized in the ECU 70 (Step, S2).

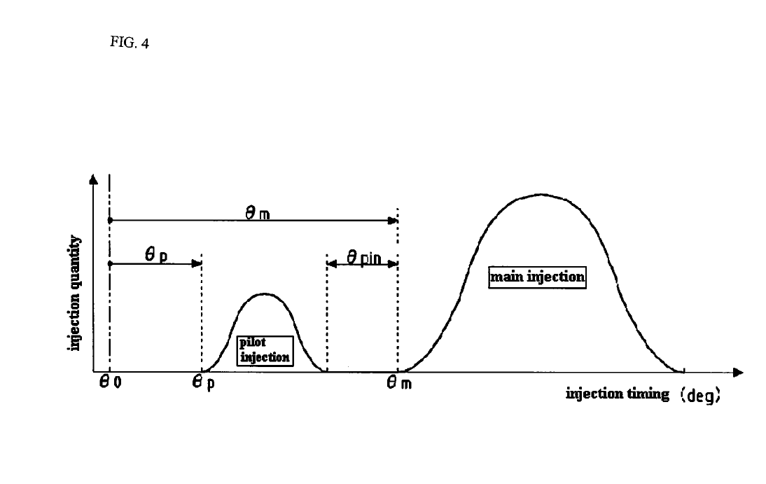

In this case, a correlation between the pilot injection timing θp and the main injection timing θm will be represented in FIG. 4.

Specifically, the pilot injection timing θp and the main injection timing θm are defined as the timing based on crankshaft angle (i.e., that the degree is defined as an unit) from a standard timing θ0.

As shown in FIG. 4, the pilot injection interval θpin means the interval (phase difference of the crankshaft angle) from the termination of the pilot injection to the starting of the main injection (i.e., the main injection timing θm).

Incidentally, the TDC in the injection one before the injection of the controlled object or the like can be adopted as the standard timing θ0.

As shown in FIG. 8, the engine rotation number Ne is averaged so as to derive an average engine rotation number Nem, and the average engine rotation number Nem is adopted as an engine rotation number, thereby removing an effect caused by the minimal rotation fluctuation of the engine (Step, S 3).

Accordingly, the pilot injection interval Tpin at the after-mentioned time base is set up to be kept approximately constant regardless of the engine rotation number.

Specifically, the engine rotation number Ne is averaged due to ten times or more time for the threshold of the pilot injection interval Tpin at the after-mentioned time base (1 (ms), in the present embodiment) so as to derive the average engine rotation number Nem. A filter having an equivalent time constant may be utilized instead of performing the averaging procedure.

As shown in FIG. 8, the pilot injection interval θpin based on crankshaft angle is converted to the pilot injection interval Tpin at the time base, on the basis of the following formula (Step, S4).

Tpin=(θp−θm)*1000/(6*Nem)

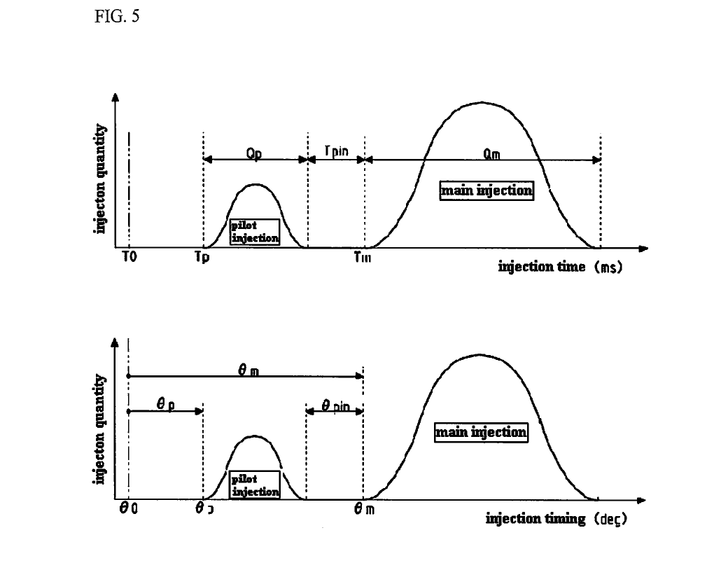

In this case, a correlation of the pilot injection timing θp, the main injection timing θm and the pilot injection interval θpin with the pilot injection interval Tpin, the pilot injection time Qp and the main injection time Qm will be indicated as FIG. 5.

As shown in FIG. 8, the main injection timing θm is evaluated on the basis of the pilot injection interval Tpin calculated by the formula 1 (Step, S5).

More specifically, when the pilot injection interval Tpin is the threshold (1 (ms), in the present embodiment) or more, the main injection timing θm is directly adopted as the main injection timing and is synchronized with the crankshaft angle obtained from a crank pulse so as to be set up to start the main injection at the main injection timing θm (Step, S8).

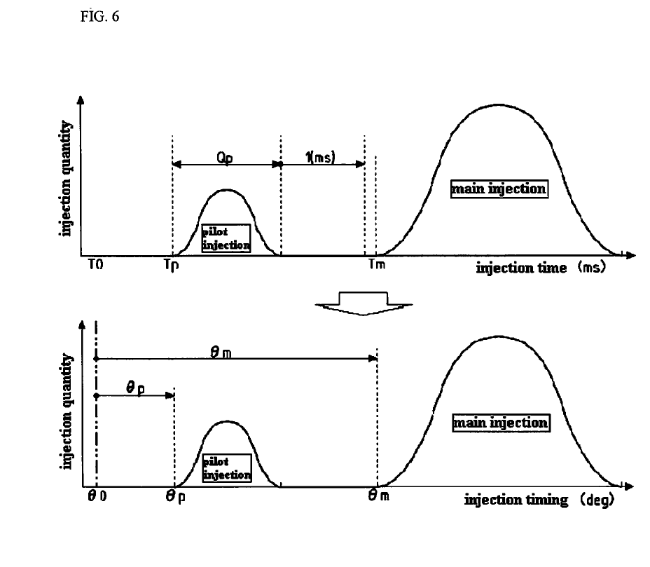

In this case, a correlation of the pilot injection timing θp, the main injection timing θm and the pilot injection interval θpin with the pilot injection interval Tpin and the pilot injection time Qp will be indicated as FIG. 6.

As shown in FIG. 8, when the pilot injection interval Tpin is less than the threshold (1 (ms), in the present embodiment), the main injection timing θm is defined as the timing delaying by a correction time Tr (i.e., a correction main injection timing Tm2), going by the pilot injection timing θp, by calculating the correction time Tr (ms) with a combination of the pilot injection time QP and the pilot injection interval Tpin. In this respect, the correction time Tr is calculated by the following formula.

Tr=Qp+Tpin

In this case (i.e., when the pilot injection interval Tpin is less than the threshold), the correction main injection timing Tm2 after a lapse of Tr from the θp is adopted as the main injection timing, based on the pilot injection timing θp based on crankshaft angle, regardless of the engine rotation number (Step, S 7).

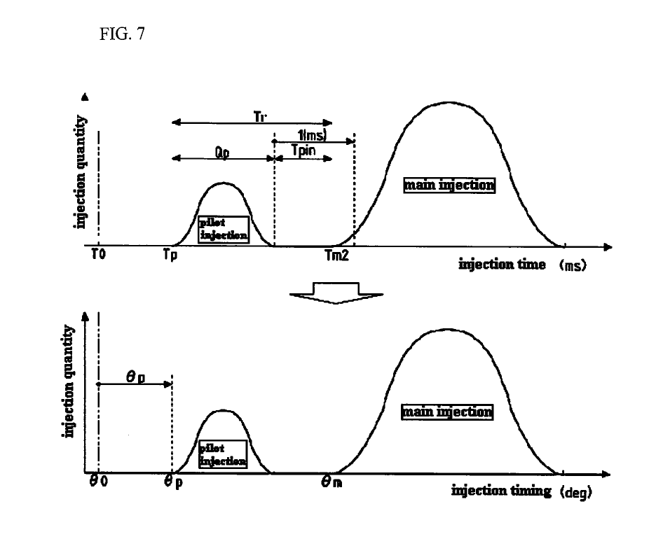

In this case, a correlation of the pilot injection timing θp, the main injection timing θm, the correction time Tr and the correction main injection timing Tm2 with the pilot injection interval Tpin and the pilot injection time Qp will be indicated as FIG. 7.

As shown in FIG. 8, a series of control operations are terminated based on the above-mentioned steps, and is moved to the upcoming control. Accordingly, the pilot injection interval is continuously controlled.

Incidentally, in the present embodiment, the threshold is set up as 1 (ms), but it is not limited to this.

Specifically, as shown in FIG. 7, when the pilot injection interval Tpin at the time base is less than the threshold, the pilot injection interval Tpin is controlled to be constant regardless of the engine rotation number, by delaying by Tr (ms) with a combination of the pilot injection time Qp and the time-converted pilot injection interval Tpin, based on the pilot injection timing θp as the main injection timing.

In this respect, the engine rotation number Ne used in converting the pilot injection timing θp based on crankshaft angle to the pilot injection interval Tpin at the time base is averaged and filtered, and the average engine rotation number Nem, which the harmful minimal rotation fluctuation is removed, is adopted, so that the pilot injection interval Tpin can be constant regardless of the engine rotation number.

Consequently, when the pilot injection interval Tpin is the threshold or more, the main injection timing θm is synchronized with the crankshaft angle, so that the engine can be adequately controlled, while even when the pilot injection interval Tpin is less than the threshold, the pilot injection interval Tpin is adequately maintained independently of the fluctuation of the engine rotation number, thereby securing the stability of the engine rotation number.

Incidentally, with respect to the actual control operation, the respective controls for the pilot injection and the main injection are performed by variably controlling the energizing timing and the energizing time of the pulse current to the solenoid 61.

Specifically, the pilot injection timing θp and the pilot injection time Qp are derived based on the map information memorized in the ECU 70, as well as the pulse current is energized to the solenoid 61, at the timing synchronized with this pilot injection timing θp, and during the time corresponding to the pilot injection time Qp.

By the same token, the main injection timing θm and the main injection time Qm are derived based on the map information memorized in the ECU 70, as well as the pulse current is energized to the solenoid 61, at the timing synchronized with this main injection timing θm and during the time corresponding to the main injection time Qm.

In the respective pilot and main injections, the injections are started by way of a certain response lag, in response to the on/off operation of the pulse current.

The method for controlling the multistage injection according to the present invention was described, as identified above.

As shown in the above-mentioned description, in the common-rail fuel injection system 100 performing the multistage injection, with respect to the method for controlling the common-rail fuel injection system 100 which controls the pilot injection timing θp based on crankshaft angle and the main injection timing θm based on crankshaft angle by the ECU 70, the pilot injection interval Tpin at the time base is calculated by the ECU 70, and when the pilot injection interval Tpin is less than the predefined threshold (1 (ms) in the present embodiment), the correction main injection timing Tm2 is adopted, so as to secure the pilot injection interval Tpin at the time base.

In other words, in the area where the main injection quantity is affected by the pilot injection interval Tpin, the fluctuation of the pilot injection interval Tpin due to the fluctuation of the engine rotation number can be prevented.

The pilot injection interval Tpin at the time base is set up to be calculated and output by the ECU 70, based on the pilot injection timing θp based on crankshaft angle, the main injection timing θm based on crankshaft angle, and the engine rotation number Ne at the calculation time.

Briefly, the area where the pilot injection interval Tpin is controlled by the time base can be reduced, by using the engine rotation number at the calculation time as the control element.

The pilot injection interval Tpin can be adequately evaluated, even at the rapid acceleration/deceleration time.

The correction main injection timing Tm2 is set up so that it becomes the timing that the pilot injection time Qp and the pilot injection interval Tpin at the time base are delayed by the time Tr (ms), going by the pilot injection timing θp at the crankshaft angle, based on the pilot injection timing θp at the crankshaft angle, the pilot injection time Qp and the pilot injection interval Tpin at the time base.

Briefly, the pilot injection interval Tpin can be adequately maintained by correcting the main injection timing θm

The present invention is applicable in the common-rail fuel injection system applied to the diesel engine.

1. A method for controlling a common-rail fuel injection system, controlling a pilot injection timing based on crankshaft angle and a main injection timing based on crankshaft angle by a controller, in the common-rail fuel injection system which performs a multistage injection, comprising the step of:
calculating a pilot injection interval at a time base by the controller, and
adjusting the main injection timing based on crankshaft angle, so as to secure the pilot injection interval at the time base, when the pilot injection interval is less than the predefined threshold.

2. The method for controlling the common-rail fuel injection system as set forth in claim 1, wherein the pilot injection interval at the time base is calculated and output by the controller, based on the pilot injection timing based on crankshaft angle, the main injection timing based on crankshaft angle and an engine rotation number at a calculating time.

3. The method for controlling the common-rail fuel injection system as set forth in claim 1, wherein a correction main injection timing at a time base is adopted as the main injection timing, by adjusting so as to delay by the time with a combination of the pilot injection time and the pilot injection interval at the time base, going by the pilot injection timing based on crankshaft angle, based on the pilot injection timing based on crankshaft angle, the pilot injection time and the pilot injection interval at the time base.
